(19) United States
(12) Patent Application Publication
(10) Pub. No.: US 2005/0238316 A1
(43) Pub. Date: Oct. 27, 2005

(54) Hybrid video on demand using mpeg2 transport

(75) Inventors: Jill MacDonald Boyce, Manalapan, NJ (US); Jeffrey Allen Cooper, Rocky Hill, NJ (US)

Correspondence Address: THOMSON LICENSING INC., PATENT OPERATIONS, PO BOX 5312, PRINCETON, NJ, 08543-5312, US

(73) Assignee: Thomson Licensing S,A,, F-92100 Boulogne-Billancourt (FR)

(21) Appl. No.: 10/527,956

(22) PCT Filed: Sep. 19, 2003
(86) PCT No.: PCT/US03/30023

§ 371 Date: Mar. 15, 2005

Related U.S. Application Data
(60) Provisional application No. 60/411,911, filed on Sep. 19, 2002.

(51) Int. Cl. H04N 7/173; H04N 7/00; H04N 5/91

(52) U.S. Cl. 386/46; 725/90; 725/87

(57) ABSTRACT

Method for providing video on demand using an MPEG-2 transport stream. The method includes receiving at a VoD player a plurality of program segments, each corresponding to a fractional part of an entire program. The method further includes the step of receiving at the VoD player a key table containing packet count information corresponding to the number of data packets contained in at least one of the program segments. Finally, an end point of at least one of the program segments is identified by counting a number of data packets that are decoded for playback.

### CROSS REFERENCE TO RELATED APPLICATIONS

This is a non-provisional application which claims the benefit of provisional application Ser. No. 60/411,911, filed Sep. 19, 2002.

### TECHNICAL FIELD

This invention relates to the field of video systems and in particular, to a system for supporting Video On Demand (VoD).

### DESCRIPTION OF THE RELATED ART

Various systems have been proposed to support Video on Demand (VoD) using broadcasting and storage on a set top box, by splitting a video program into segments, and broadcasting each segment periodically. Some of the approaches are Harmonic Broadcasting, Cautious Harmonic Broadcasting, Polyharmonic Broadcasting, and Pagoda Broadcasting. Video on demand systems are described in A. Hu, “Video-on-demand broadcasting protocols: A comprehensive study,” in Proc. IEEE INFOCOM, April 2001, and in ISO/IEC 13818-1, “Generic coding of moving pictures and associated audio information: Systems,” 1996.

Polyharmoic Broadcasting Protocol with Partial Preloading (PBP-PP) is discussed in a conference paper entitled Zero-Delay Broadcasting Protocols for Video-on-Demand by J. Paris, S. Carter, and P. Mantey, 1999 ACM Multimedia Conference, Orlando, Fla. pp 189-197. In PBP, the first segment of a program is stored locally at a consumer premises set top box (STB). The program is split into n segments of equal duration and will preload m of these segments. A separate data stream is then dedicated to each of the remaining n−m segments. The bandwidth bᵢ at which segment Sᵢ will be transmitted must always be sufficient to guarantee that Sᵢ will be always be completely downloaded by the client STB by the time that the customer has finished watching the previous segment. For segments of equal duration d, each segment i must be transmitted at least every d/(m+i).

In the PBP-PP system, as soon as a customer begins to watch a given program, immediately all broadcast segments of that program that are received are stored on the STB. The STB must be capable of simultaneously recording all n streams. If the broadcasting schedule described above is adhered to, it is guaranteed that all of the data of segment Sᵢ will have been received by the time that segment Sᵢ should be played. However recording of segment Sᵢ will not likely start at the beginning of segment Sᵢ, but at some unknown place in the middle of segment Sᵢ, as a customer may begin watching a program at any random time. It is not described in the referenced conference paper how the STB will determine the beginning and end of segment Sᵢ. The transport protocol used to transmit the programs is also not identified in the reference.

MPEG-2 systems define transport packets and Packetized Elementary Streams (PES). Both may contain audio and video compressed data. Video data is compressed into variable bitrate frames. In general, video frames are not packet aligned. Packetized Elementary Stream (PES) packets may be encapsulated in transport packets. MPEG-2 transport packets are fixed size packets, and do not contain unique sequence numbers. Program Clock References (PCRs) may be optionally sent with each transport packet.

### SUMMARY OF THE INVENTION

VoD is a desirable service to be offered to broadcast customers. Various systems have been proposed to support VoD in a broadcast environment using STB storage, For example some of these systems propose to split a video program into segments, broadcast each segment periodically, and store the segment on a set top box. However, such systems do not provide a solution to operating such protocols using MPEG-2 systems as the transport protocol. This invention shows how MPEG-2 systems can be used as the transport mechanism for such a broadcasting protocol.

### BRIEF DESCRIPTION OF THE DRAWINGS

FIG. 1 is a drawing that is useful for understanding the basic digital video architecture of the invention from source to viewer.

FIG. 2 is a drawing that is useful for understanding MPEG-2 Program Structure

FIG. 3 is a block diagram of a video on demand player that can be used with the present invention.

FIG. 4 is a video data transmission and playback timing diagram that is useful for understanding the invention.

### DETAILED DESCRIPTION OF THE PREFERRED EMBODIMENTS

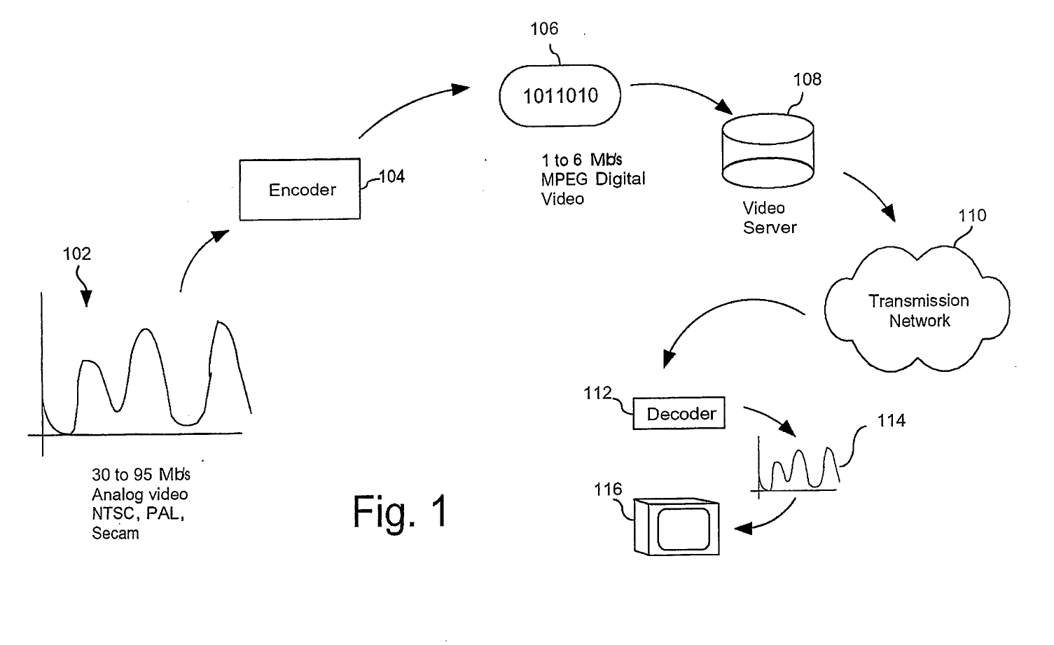

The current invention concerns the use of an MPEG-2 transport stream in a Video on Demand (VoD) system using Polyharmoic Broadcasting Protocol with Partial Preloading (PBP-PP), or a similar type of broadcasting protocol. In conventional VoD system, there is provided a VoD player at the consumer premises, and a video broadcasting server at some other location. FIG. 1 shows the basic features of such a system. As illustrated therein, an MPEG-2 digital video encoder 104 can be used to generate an MPEG-2 transport stream 106 that is communicated to a video server 108 for distribution upon demand. The transport stream data can be communicated to a decoder 112 by way of a transmission network 110. The decoder reconstructs the original analog signal and communicates the signal in a conventional analog format to a video display unit.

The MPEG-2 transport stream is created by encoder 104 by converting analog source audio and video content 102 to an elementary stream (ES) comprised of separate audio and video digital data. This is conventionally accomplished using MPEG-2 compression algorithms that are well known in the art. The ES can be thought of as being essentially endless, since its overall length will correspond to the length of the program material. Each audio and video ES is divided into packets of variable lengths to produce a Packetized Elementary Stream (PES). Each individual packet comprises a header and payload bytes. Information contained in the header relates to the encoding process. This information is required by the MPEG decoder 112 to be able to decompress the ES. The PES is essentially a logical construct and is not typically used for interchange, transport, and interoperability.

Audio and video information is encoded as separate PESs. The PES packets are multiplexed to form both the Transport Stream (TS) and/or the Program Stream (PS). The TS is intended for transmission over lossy networks whereas the PS is used for non-lossy transmission media such as DVD players. The TS is formed by inserting in the PES additional packets containing tables needed to demultiplex the TS. These tables are collectively referred to as the Transport Stream Information (TSI).

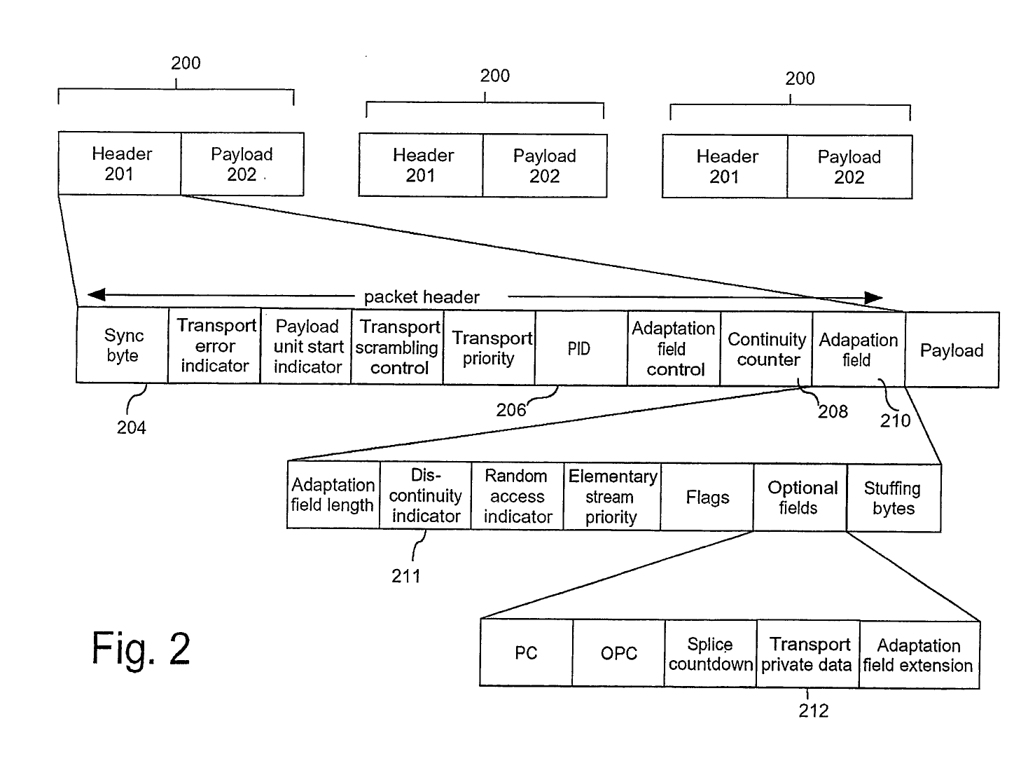

The structure of the TS is shown in FIG. 2. As illustrated therein, TS is comprised of packets 200 including a header 201 and payload 202. The header 201 is a minimum of 4-bytes including the sync byte 204 and the packet ID (PID) 206. The sync byte delineates the beginning of a TS packet. The PID is a unique address identifier. Each video and audio stream has a unique PID. Similarly, each PSI table is assigned a unique PID. The PID is used to permit proper reconstruction of a program from all of its various audio, video and table packets.

The TS header contains several other important fields that are illustrated in FIG. 2. These include the continuity counter field (208) that is used to determine if packets are lost or repeated. Some packets will also contain timing information for their associated program. This information is called program clock reference (PCR). The PCR is inserted in one of the optional fields of the TS packet. The PCR is used to allow the decoder to synchronize its clock to the same rate as the original encoder clock. A discontinuity indicator field 210 is provided to help identify any discontinuity in the time base (PCR) and continuity counter.

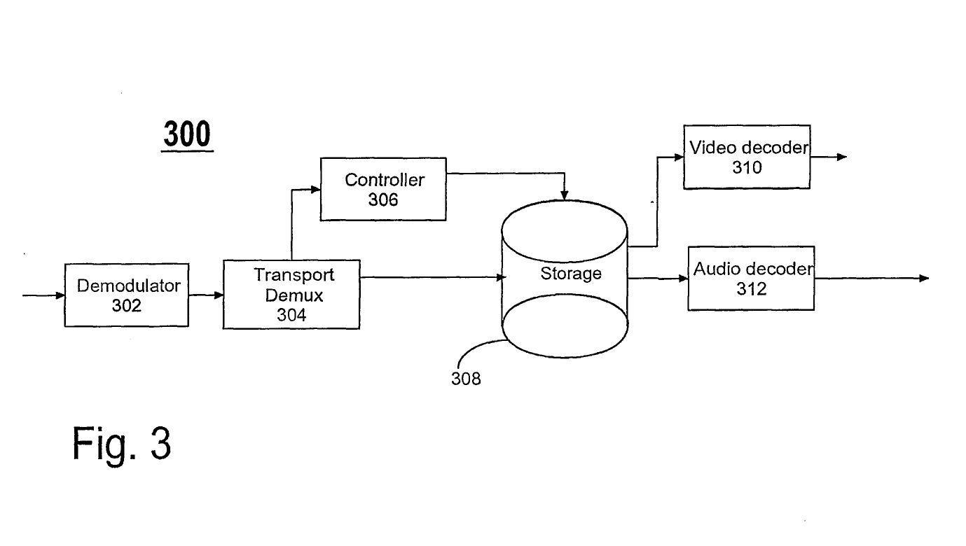

Referring now to FIG. 3, it can be seen that a video on demand (VoD) player 300 includes a demodulator 302, a transport de-multiplexer 304, a controller 306, storage 308, a video decoder 310 and an audio decoder 312. The storage 308 in the VoD player may be a hard disk drive or any other suitable rewritable storage medium.

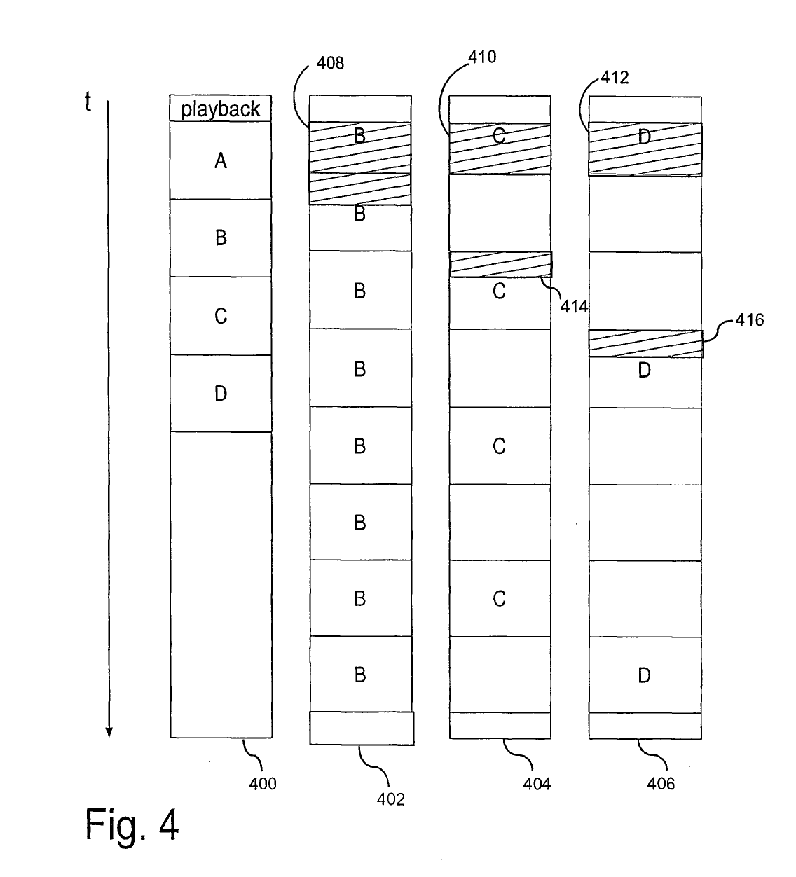

Referring now to FIG. 4, it can be observed that when PBP-PP or similar protocols are used, a video program is split into several segments A, B, C and D each segment broadcast in its own stream 402, 404, 406. Those skilled in the art will appreciate that although four segments A, B, C, and D are shown in FIG. 4, more or fewer segments can also be used. In this regard, it should be understood the four segments in FIG. 4 are presented merely as an example and are not intended to limit the invention. If MPEG-2 transport packets are used, each stream 402, 404, 406 can be identified by using a different PID 206. The VoD player is preferably capable of storing multiple segments A, B, C and D during the same time window, and hence must be capable of demodulating all signals that contain the multiple segments. All segments can be broadcast concurrently, for example, on the same satellite transponder, in which case the demodulator would automatically demodulate all of the streams. Alternatively, in a system with a demodulator capable of demodulating multiple transponder channels simultaneously, the streams could be broadcast concurrently on different satellite transponder channels. As used herein, transmitting concurrently means that packets containing data from two segments are multiplexed together and transmitted interspersed with each other, but are not necessarily sent at exactly the same time.

Referring to FIG. 4, it may be observed that when a user begins to watch a program, the VoD player begins presenting a playback stream 400 by playing back the initial segment A, which can be already stored in the storage. The initial segment A that is intended for playback before all of the other segments associated with an entire program can be broadcast at an earlier time, possibly on a different channel, or on a different transponder as compared to the remaining segments. Consequently, the initial segment can be received and stored at the VoD player on storage 308 in advance of playback. The initial segment A may be unencrypted and available to all users as a preview, with later segments encrypted and requiring purchase to view. In addition the initial segment may be broadcast less frequently than the other segments, for example once a day, or only as often as a new program is available on the system. Alternatively, segment A need not be present in storage and can instead be transmitted at frequent time intervals on the same or a different channel and of relatively short length so that only a short delay occurs when a user wishes to begin viewing the program.

When the compressed audio/video data of the initial segment is broadcast, information is also broadcast about how many segments are associated with a given program, their PIDs, and the size in bytes of these segments. This data can also be stored on storage 308 in any other suitable storage provided at the VoD player.

When the user begins to watch a program, the VoD player initiates playback of the initial segment A, stored previously in the storage 308. The demodulator 302 demodulates the received signal and the controller 306 determines which PIDs correspond to segments A, B, C. and D of the program being viewed. The transport demux 304 passes through the data packets 200 identified with those PIDs, and they are stored in the storage.

When the user starts to watch the program, segment A's data is passed to the video and audio decoders 310, 312. In this example, all of segment B's data 401 and portions 410, 412 of segments C and D are stored while segment A is being played. All of segment B is stored while segment A is being played, but it is not received starting with the beginning of segment B, but in the middle of segment B. While segment B is being played, the remaining portion 414 of segment C is stored. By the time playing of segment B is completed, all of segment C has been stored. While segment C is being played, the remaining portion 416 of segment D is stored.

According to a preferred embodiment, the VoD player controller 306 is capable of identifying the beginning and end of each segment so that the audio and video decoders are smoothly fed compressed data corresponding to contiguous video frames, without gaps, freezes, overlaps or re-ordering or packets. MPEG-2 transport packets cannot be easily individually identified. PCRs are sent infrequently in the MPEG-2 transport packets, as significant overhead is needed to send the PCRs, which are expressed in 27 MHz clock ticks.

In a first inventive arrangement the MPEG-2 transport stream includes packet count information relating to the transmitted data packets relative to the beginning of a segment of a program. Given this information, the VoD player controller can recognize when the number of packets is approaching a value corresponding to the end of a segment A, B, C, or D. The segment packet count (SPC) value corresponding to the beginning and end of each segment can be communicated to the VoD player at the same time as segment A or at any convenient time prior to playback of each segment. Once again, it should be noted that a larger or lesser number of segments can be used without departing from the invention.

The segment packet count (SPC) field is broadcast as part of the MPEG-2 transport stream. The SPC data can be embedded within the MPEG-2 transport stream in any convenient location. For example, and without limitation, the SPC field can be broadcast as private data 212 in the adaptation field 210 of the MPEG-2 transport stream. At least once per group of packets corresponding to some time t worth of audio/video data, the SPC field is advantageously broadcast for each segment. The SPC field for a segment may be in a transport packet with the same PID as the compressed data, either in its own packet or in a packet containing compressed data. A VoD player can compare the timing information contained in the segment packet count (SPC) field to the number of packets expected in each segment, to cleanly identify where each segment begins and ends. In this way, the segments A, B, C, and D can be smoothly and contiguously supplied to a video decoder.

In a further inventive arrangement segment packet counts SPCs for multiple segments can be combined into the same transport packet, with each segment having a separate PID. In this case, both the PID and associated SPC must be transmitted for each segment represented in this transport packet. The two low order bits of the SPC may be not transmitted and derived from the continuity counter field.

As previously described, the initial program segment may be unencrypted and available to all users for previewing. In addition this initial program segment can advantageously include a key table which associates subsequent program segments with PIDs and other details such as number of packets per segment in anticipation of program selection by the viewer. A VoD player which simultaneously stores all received segments of a given program can employ the pre-recorded key table delivered with the initial program segment to identify the received PIDs. This information can be stored in storage 308 or any other suitable memory location at the VoD player 300.

When the user begins to watch a program, the controller 306 of VoD player watches for packets containing SPCs to be received for all PIDs corresponding to the various segments of a sequence. As soon as an SPC value is received, the VoD player records that first received SPC value in memory, and stores the data packets with that PID following the SPC. As data packets with that PID are received, the SPC fields received are monitored. An internal counter may be kept by controller 306 that increments with each packet received, in order to identify missing packets. Once packets are received with SPC values corresponding to packets in the segment already stored in storage 308, the VoD player may either discard the received packets, or overwrite the currently stored packets. Error resiliency may be achieved by checking to see if missing or corrupted data were received earlier and storing a correctly received packet instead. Better error resiliency can be obtained if the number of packets in each segment were known at the VoD player in advance. As noted above, this information can be broadcast earlier as part of a key table along with the initial segment A.

An example syntax is shown below for sending segment information with the initial segment. Fields in bold are transmitted.

num_programs
for (i=0; i<num_programs; i++)
{

num_segments[i]
video_size[i]
num_audio_tracks;
for(k=0;k<num_audio_tracks;k++){
audio_size[i][k]
}
for (j=0; j<num_segments[i]; j++){

pid_video[i][j]
num_packets_video[i][j]
for(k=0;k<num_audio_tracks;k++){

pid_audio[i][j][k]

num_packets_audio[i][j][k]
}

}
}

In an alternative embodiment, for some broadcast environments with very low probability of packet loss (e.g. satellite, cable), then the error resiliency aspect of the SPC is not needed. Therefore, the SPC is not needed and the continuity counter can be used along with the number of packets (num_packets) per segment. When the controller begins recording a segment, it counts the number of packets. It can determine when the end of the segment is reached by the large discontinuity in the value of the (SCR)/Presentation Time Stamp (PTS) fields. At this point, it notes that this is the beginning of the segment. When the total number of packets is received, then recording of this segment is complete. The continuity counter is only used to identify lost packets. Typical video/audio error concealment techniques are used in the VoD player.

In conventional PBP-PP systems, the program is split into n segments of equal duration and will preload m of these segments. A separate data stream is then dedicated to each of the remaining n−m segments. The bandwidth bᵢ at which segment Sᵢ will be transmitted must always be sufficient to guarantee that Sᵢ will be always be completely downloaded by the client STB by the time that the customer has finished watching the previous segment. For segments of equal duration d, each segment i must be transmitted at least every d/(m+i). For a system using the current invention to guarantee delay-free playback, the segments are preferably broadcast slightly more frequently, each d/(m+i)−t, rather than each d/(m+i). If t is small compared to d, the increase in bandwidth is small.

Those skilled in the art will appreciate that segments may contain different numbers of packets, and may correspond to different lengths of time without requiring additional complexity at the decoder. However scheduling at the video server is complicated by variable sized segments.

When the stored compressed audio/video data is fed to the audio and video decoders 310, 312, it must contain timing information, such as Presentation Time Stamps (PTS) and Decoder Time Stamps (DTS), which are consistent across the multiple segments. The PTS and DTS fields present in the transport packets are coded relative to the Program Clock Reference (PCR) at transmit time, and hence will be not be consistent across the segment boundaries. According to a preferred embodiment, PES packets with the correct playback timing information for all segments can be embedded in the transport packets. Or in a different embodiment, the VoD player could derive the timing information from the transport packets and create PES packets with accurate information, and store the PES packets instead of the transport packets.

The controller in the VoD player must keep track of available memory capacity or storage space. When the user decides to watch a program the controller must determine if the enough space is remaining on the storage 308 to record all the segments required. Therefore, total size of the video (video size) and each audio track (audio_size) for the entire program can be sent together with the key table as noted above. According to one embodiment, the size for each unique PID channel can be sent and the controller can sum the selected PID program sizes together. This is more optimum for determining the exact memory storage size requirement, however it requires larger number of terms sent {size per PID}). Alternatively a single program_size can be sent which is the size of the remaining video segments plus the size of the remaining audio segments for the largest audio channel. The controller 306 can determine if enough room is available in the storage 308.

If space is available, then playing of the content begins. If additional space is required, then the controller can give the user several options depending on the capability of the box. For example, the user interface could suggest other programs to be removed based on program age, program size, and so on. According to a preferred embodiment, in order to reduce the storage required on the HDD of the VoD player, only one audio channel will be saved. That is, only one language track.

1. A method for providing video on demand playback, comprising:
receiving at a VoD player a plurality of program segments, each corresponding to a fractional part of an entire program
receiving at said VoD player a key table containing packet count information corresponding to the number of data packets contained in at least one of said program segments;
identifying an end point of at least one of said plurality of program segments by counting a number of data packets that are decoded for playback.

2. The method according to claim 1 further comprising the step of counting a number of data packets relative to the beginning of a program segment.

3. The method according to claim 1 further comprising the step of associating at least one program segment with a unique program identifier (PID) based on information contained in said key table.

4. The method according to claim 1 further comprising the step of receiving and recording at said VoD player at least part of one of said plurality of program segments during the playback by said VoD player of a previous one of said plurality of program segments.

5. The method according to claim 1 further comprising the step of beginning a playback of at least one of said plurality of program segments responsive to a determination that a preceding one of said plurality of segments in said program is approaching said end point.

6. The method according to claim 1 further comprising the step of receiving at said VoD player a segment packet count data for one or more of said plurality of program segments, said SPC data identifying a position within a program segment of a received packet containing program segment data.

7. The method according to claim 6 wherein said SPC data is private data in the adaptation field of the MPEG-2 transport.

8. The method according to claim 6 further comprising the step of monitoring said SPC field of data packets received at said VoD player.

9. The method according to claim 8 further comprising the step of comparing said SPC field data to a number of data packets contained in at least one of said plurality of program segments to identify the occurrence of missing packets.

10. The method according to claim 8 further comprising the step of discarding packets received by said VoD player that have SPC field data values corresponding to packets that have already been stored by said VoD player.

11. The method according to claim 8 further comprising the step of counting a number of data packets received by said VoD player for at least one of said plurality of program segments.

12. The method according to claim 11 further comprising the step of determining that a segment has been completely received when a total number of packets received for a segment is equal to a total number of packets for said segment as identified by said SPC data in said key table.

13. The method according to claim 12 further comprising the step of determining an end of a segment based upon a discontinuity in at least one of a system clock reference field and a presentation time stamp field.

14. A method for providing video on demand playback, comprising:
defining a plurality of program segments, each corresponding to a fractional part of an entire program;
transmitting at least two of said plurality of program segments concurrently, with each program segment separately identifiable based upon a unique packet identifier;
broadcasting one or more earlier ones of said plurality of segments, that chronologically are intended to precede later segments in said program, more frequently than said later segments.

15. The method according to claim 14 further comprising the step of broadcasting with at least one of said plurality of program segments a key table containing packet count information corresponding to the number of data packets contained in at least one of said program segments.

16. A video on demand player comprising:
demultiplexor means for demultiplexing a plurality of multiplexed program segments, each having a unique packet identifier and each corresponding to a fractional part of an entire program;
storage means for concurrently storing two or more of said plurality of program segments during a predetermined time period.

17. The VoD player according to claim 16 further comprising means for receiving and storing a key table containing packet count information corresponding to a number of data packets contained in at least one of said program segments.

18. The VoD player according to claim 17 further comprising means for identifying at least one of a beginning and an end of one or more of said plurality of program segments using said packet count information.

19. The VoD player according to claim 17 further comprising means for determining, based on said packet count information, when a complete set of program segment data packets has been received.

20. The VoD player according to claim 17 further comprising means for determining a playback order of said plurality of program segments based on said packet count information.

21. The VoD player according to claim 20 further comprising means for playing back in order and without interruption a first and all subsequent ones of said plurality of program segments.

22. The VoD player according to claim 17 further comprising means for receiving and storing at least a first program segment corresponding to a beginning portion of said entire program on at least one of a different transponder channel and at a different time as compared to a remainder of said program segments.

23. A VoD server comprising:
means for defining a plurality of program segments, each corresponding to a fractional part of an entire program
means for multiplexed transmitting at least two of said plurality of program segments concurrently, with each program segment separately identifiable based upon a unique packet identifier;
means for broadcasting one or more earlier ones of said plurality of segments, that chronologically are intended to precede later segments in said program, more frequently than said later segments.

24. The VoD server according to claim 23 further comprising means for broadcasting with at least one of said plurality of program segments a key table containing packet count information corresponding to the number of data packets contained in at least one of said program segments.

25. The VoD server according to claim 23 further comprising means for transmitting a segment packet count data for one or more of said plurality of program segments, said SPC data identifying a position within a program segment of a transmitted packet containing program segment data.

26. The VoD server according to claim 25 wherein said SPC data is private data in the adaptation field of the MPEG-2 transport.

27. The VoD server according to claim 23 further comprising means for transmitting at least a first program segment corresponding to a beginning portion of said entire program on at least one of a different transponder channel and at a different time as compared to a remainder of said program segments.
